(19) United States
(12) Patent Application Publication
(10) Pub. No.: US 2026/0270585 A1
(43) Pub. Date: Sep. 10, 2026

(54) SOLID-STATE IMAGING DEVICE WITH PIXEL CIRCUITS OUTPUTTING PIXEL NOISE SIGNALS AND PIXEL DATA SIGNALS

(71) Applicant: Sony Semiconductor Solutions Corporation, Atsugi-shi, Kanagawa (JP)

(72) Inventors: Erik Robert JOHANSSON, Stuttgart (DE); Tore MARTINUSSEN, Stuttgart (DE)

(73) Assignee: Sony Semiconductor Solutions Corporation, Atsugi-shi, Kanagawa (JP)

(21) Appl. No.: 19/166,491

(22) PCT Filed: Mar. 13, 2024
(86) PCT No.: PCT/EP2024/056624

§ 371 Date: Sep. 18, 2025

(30) Foreign Application Priority Data
Mar. 30, 2023 (EP) 23165713.1

(51) Int. Cl. H04N 25/618; H04N 25/78; H04N 25/79

(52) U.S. Cl. CPC H04N 25/618; H04N 25/78; H04N 25/79

(57) ABSTRACT

A solid-state imaging device includes a plurality of pixel circuits. Each pixel circuit outputs a pixel data signal and a pixel noise signal. A voltage level of the pixel data signal is a function of an intensity of incident radiation detected in an exposure period. A voltage level of the pixel noise signal is a function of temporal noise in the pixel circuit and independent from the incident radiation. Column signal processing circuits convert the pixel data signals into digital pixel data values DS and the pixel noise signals into digital pixel noise values DR. A row noise block continuously obtains a parameter of a distribution of the pixel noise values DR and outputs a signal based on the parameter.

The present disclosure relates to a solid-stage imaging device having active pixel circuits that output analog pixel data signals and analog pixel noise signals. In particular, the present disclosure relates to analyzing and/or reducing the effects of row temporal noise from active pixel circuits.

### BACKGROUND

An image sensor assembly for a solid-state imaging device includes photoelectric conversion elements that generate photocurrents proportional to the intensity of incident radiation. Active pixel circuits convert the photocurrents to analog pixel data signals, wherein within a sensitivity range of the active pixel circuit, a voltage of the analog pixel data signal is a monotonically increasing function of the photocurrent. Via data signal lines, the pixel data signals of active pixel circuits belonging to a same pixel column are sequentially transmitted to a column signal processing unit in row readout periods. In addition to each pixel data signal, the active pixel circuit transmits in each row readout period an analog pixel noise signal to the column signal processing unit. The pixel noise signal originates from a non-illuminated period of the active pixel circuit. The column signal processing unit converts the received pixel data signals into digital pixel data values, converts the received pixel noise signals into digital pixel noise values, and subtracts the pixel noise value from the pixel data value obtained in the same row readout period to obtain corrected pixel values. In the corrected pixel values the effects of row temporal noise are reduced.

### SUMMARY

Since the pixel data signal and the pixel noise signal are sampled at different times, subtracting the pixel noise value from the pixel data value obtained in the same row readout does not necessarily completely remove the noise from the pixel data signal. In particular, the high frequency component of the noise remains nearly unaffected. Another method of reducing row noise is to pass the power supply noise through an alternate circuit and subtract the noise passed through the alternate circuit from the pixel data signal at an appropriate network node of the column signal processing unit. The choice of parameters of the alternative circuit, such as gain and cut-off frequency, is not trivial.

The present disclosure mitigates such shortcomings of the prior art. In particular, the present disclosure provides a solid-state imaging device in which a row noise block continuously receives pixel noise values from pixel circuits connected to the same column signal processing circuit. The row noise block may statistically evaluate the pixel noise values from the same pixel circuits from which the pixel data values originate. The results of the evaluation can be used in various ways to reduce noise and/or improve device safety.

Accordingly, a solid-state imaging device includes a plurality of pixel circuits. Each pixel circuit outputs a pixel data signal and a pixel noise signal. A voltage level of the pixel data signal is a function of an intensity of incident radiation detected in an exposure period. A voltage level of the pixel noise signal is a function of temporal noise in the pixel circuit and independent from the incident radiation. Column signal processing circuits convert the pixel data signals into digital pixel data values DS and the pixel noise signals into digital pixel noise values DR. A row noise block continuously obtains a parameter of a distribution of the pixel noise values DR and outputs a signal based on the parameter.

The row noise block may continuously feed information back to the column signal processing circuit to update parameters of a noise reduction circuit, may feed noise information forward to reduce the noise in a downstream circuit, and/or may signal critical conditions to a higher-level processing instance, to give examples.

### BRIEF DESCRIPTION OF THE DRAWINGS

A more complete understanding of the disclosure and many of the advantages associated therewith will be obtained by reference to the following detailed description in conjunction with the accompanying drawings, in which:

FIG. 1 is a schematic block diagram illustrating an imaging apparatus as an example for an electronic device including a solid-state imaging device with active pixel circuits, in accordance with the embodiments.

FIG. 2 is a simplified block diagram illustrating a configuration example of a solid-state imaging device with a row noise block that obtains a parameter of a distribution of pixel noise values, in accordance with an embodiment.

FIG. 3 is a schematic diagram illustrating an embodiment in which a solid-state imaging device has a two-layer structure in a stacked CIS configuration.

FIG. 4 is a simplified block diagram illustrating a configuration example of a portion of a solid-state imaging device with a row noise block that obtains a parameter of a distribution of pixel noise values, in accordance with an embodiment.

FIG. 5 is a simplified block diagram illustrating a configuration example of a solid-state imaging device with a row noise block that obtains a parameter of a distribution of pixel noise values, in accordance with an embodiment concerning a digital processing unit that includes ab arithmetic logic unit.

FIG. 6 is a simplified block diagram illustrating a configuration example of a solid-state imaging device with a row noise block that obtains a parameter of a distribution of pixel noise values, in accordance with an embodiment concerning a safety integrity block outputting information about critical conditions.

FIG. 7 is a time diagram schematically illustrating the operation of the configuration example of FIG. 6.

FIG. 8 is a simplified block diagram of an active pixel circuit and a column signal processing circuit of a solid-state imaging device, in accordance with an embodiment using the row noise block to update parameters of a noise reduction circuit in the column signal processing circuit.

FIG. 9 is a simplified time diagram illustrating input signals, internal signals, and output signals of the column signal processing circuit of FIG. 8 in accordance with an embodiment.

FIG. 10 is a simplified block diagram illustrating a configuration example of a solid-state imaging device with a row noise block that obtains a parameter of a distribution of pixel noise values, in accordance with an embodiment using the row noise block to update parameters of a noise reduction circuit in the column signal processing circuit of FIG. 8.

FIG. 11 is a simplified diagram illustrating the mode of operation of a regulator unit illustrated in FIG. 10 in accordance with an embodiment.

FIG. 12 is a simplified block diagram illustrating a configuration example of a solid-state imaging device with a row noise block that obtains a parameter of a distribution of pixel noise values, in accordance with an embodiment concerning a feed forward of noise information to a downstream circuit.

FIG. 13 is a time diagram schematically illustrating the operating principle of the configuration example of FIG. 12.

FIG. 14 is a simplified block diagram illustrating a configuration example of a solid-state imaging device with a row noise block that obtains a parameter of a distribution of pixel noise values, in accordance with an embodiment combining several embodiments.

FIG. 15 is a block diagram depicting an example of a schematic configuration of a vehicle control system, in accordance with embodiments of the present disclosure

FIG. 16 is a diagram of assistance in explaining an example of installation positions of an outside-vehicle information detecting section and an imaging section of the vehicle control system of FIG. 15.

### DETAILED DESCRIPTION

Embodiments for implementing techniques of the present disclosure will be described below in detail using the drawings. The techniques of the present disclosure are not limited to the described embodiments, and various numerical values and the like in the embodiments are illustrative only. The same elements and elements with the same functions are denoted by the same reference signs. Duplicate descriptions are omitted.

Connected electronic elements may be electrically connected through a direct and permanent low-resistive connection, e.g., through a conductive line. The terms “connected”, “electrically connected” and “signal-connected” may also include a connection through other electronic elements provided and suitable for permanent and/or temporary signal transmission and/or transmission of energy. For example, electronic elements may be electrically connected or signal-connected through resistors, capacitors, and electronic switches such as transistors or transistor circuits, e.g., FETs, transmission gates, complementary switches, an FET and a dummy switch electrically connected in series, and others.

The load path of a transistor is the controlled current path through a transistor. For example, a voltage applied to the gate of a field effect transistor (FET) controls the current flow through the load path (controlled path) between source and drain of the FET by field effect. When it is described that a transistor is connected in series with another element or is connected in parallel with another element, this connection refers to the load path of the transistor.

A digital signal alternates between at least one active level and at least one passive level. A digital signal having an active level is active. A digital signal having an inactive level is inactive. The active level can be a digital high level or a digital low level. The inactive level can be a digital low level or a digital high level.

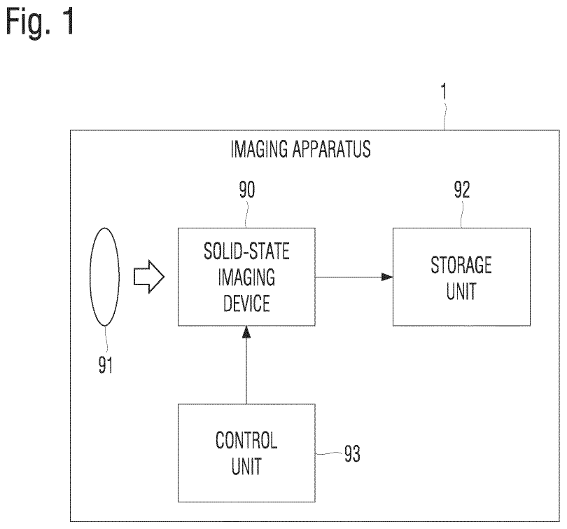

In FIG. 1, an imaging apparatus 1 includes an optical system 91, a solid-state imaging device 90, a storage unit 92, and a control unit 93. The optical system 91 includes one or more lenses and various mechanisms such as an autofocus mechanism and a diaphragm mechanism, and guides light from an object to a light receiving surface of the solid-state imaging device 90.

The solid-state imaging device 90 includes an image sensor having a plurality of active pixel circuits. Each pixel circuit converts incident radiation into electric signals by photoelectric conversion, and outputs analog pixel signals with a voltage monotonically increasing with increasing intensity of the incident radiation. The solid-state imaging device 90 converts the analog pixel signals into digital pixel values and further includes a signal processing unit that performs predetermined signal processing on the digital pixel values to obtain image data.

The storage unit 92 stores the image data, e.g., frames output from the solid-state imaging device 90 in a storage medium. The storage medium may include a volatile storage medium and/or non-volatile storage medium. The non-volatile storage medium may be or include a flash memory or a hard disk drive. The non-volatile storage medium may be or include a dynamic random access memory (DRAM).

The control unit 93 controls the solid-state imaging device 90 such that the solid-state imaging device 90 performs an imaging operation. The imaging operation includes obtaining images from a scene and outputting image data including information about the images.

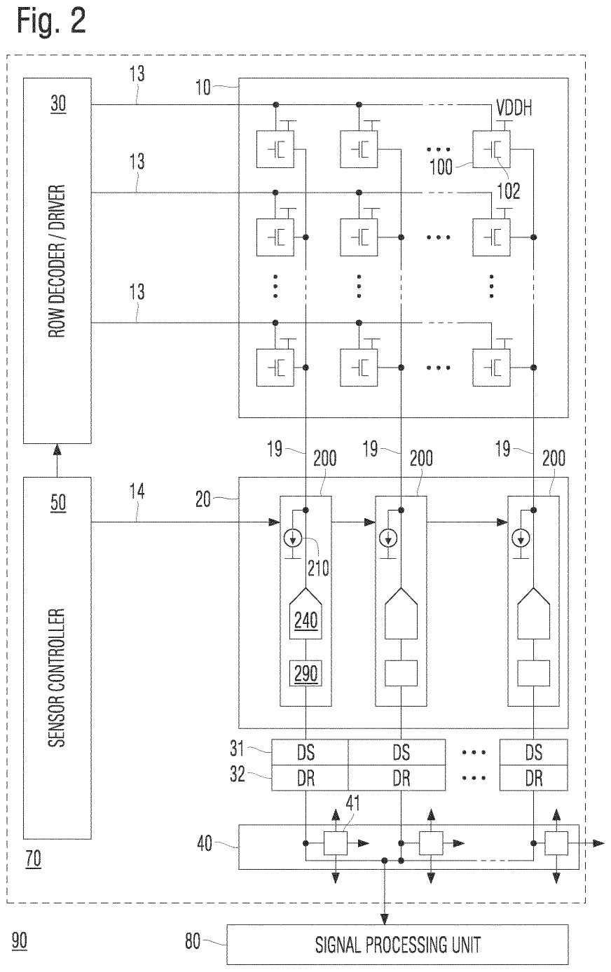

FIG. 2 illustrates a configuration example of a solid-state imaging device 90 in accordance with embodiments of the present technology. The solid-state imaging device 90 may include a signal processing unit 80 and an image sensor assembly 70. The image sensor assembly 70 may include a pixel array 10, a column signal processing unit 20 that includes a plurality of column signal processing circuits 200, a row decoder/driver 30, a digital processing unit 40, and a sensor controller 50.

The pixel array unit 10 includes a plurality of identical pixel circuits 100. The pixel circuits 100 may be any active pixel sensors (APC) for intensity readout with one or two photoelectric conversion and three, four or more FETs. The pixel circuits 100 convert incident radiation into a pixel internal voltage that is a monotonic function of the intensity of incident radiation detected by the pixel circuit 100 in an exposure period. A pixel circuit 100 outputs an analog pixel signal controlled by the pixel internal voltage to a data signal line 19, when it is selected in a row readout period. The analog pixel signal is a pixel data signal or a pixel noise signal.

The pixel circuits 100 may be arranged matrix-like in columns and rows. A subset of pixel circuits 100 assigned to the same column form a pixel column. A subset of pixel circuits 100 assigned to the same row form a pixel row.

The row decoder/driver 30 controls the pixel circuits 100 by generating pixel control signals for operating and selecting groups of pixel circuits 100. The pixel control signals control reset states, exposure time, internal temporal storage of the illumination information, and the readout of the pixel circuits 100.

The row decoder/driver 30 controls all pixel circuits 100 of a selected group of pixel circuits 100 synchronously. The selected group of pixel circuits 100 may include some pixel circuits 100 of one pixel row, all pixel circuits 100 of one pixel row, or some or all pixel circuits 100 of more than one pixel row. The following part of the description refers to “pixel rows” as examples for “groups of pixel circuits” for simplicity. The row decoder/driver 30 outputs the control signals for operating the FETs of the pixel circuits 100 on pixel control lines 13 according to driver timing signals supplied from the sensor controller 50.

The pixel circuits 100 of a pixel output group sequentially pass information about the pixel internal voltage that depends on an illumination intensity detected by the pixel circuits 100 in an exposure period to at least one data signal line (vertical signal line) 19. Each pixel output group may include some pixel circuits 100 of one pixel column, all pixel circuits 100 of one pixel column, or some or all pixel circuits 100 of more than one pixel column. The following part of the description refers to “pixel columns” as examples for “pixel output groups” for simplicity.

The pixel circuit 100 includes an amplifier transistor 102 that can be in a source follower configuration with elements of the column signal processing circuit 200. A load path of the amplifier transistor 102 is electrically connected between a pixel supply voltage VDDH and the data signal line 19. Each data signal line 19 sequentially conveys analog pixel signals from the pixel circuits 100 of one of the pixel columns to the column signal processing circuit 200.

The column signal processing circuit 200 includes a current source circuit 210 forming the load of the amplifier transistor 102 of the selected pixel circuit 100, an analog-to-digital converter 240 converting the analog pixel signals into digital pixel values and may include a digital circuit 290 preprocessing the digital pixel values. In particular, the analog-to-digital converter 240 converts the analog pixel data signals into digital pixel data values DS and the analog pixel noise signals into digital pixel noise values DR.

The digital circuit 290 may store the pixel data value DS in a data phase memory 31 and the pixel noise value DR obtained in the same row readout period in a reset phase memory 32.

The digital processing unit 40 may include an arithmetic logic unit (ALU) that preprocesses the stored pixel data value and pixel noise value. The ALU may calculate a corrected pixel value from the pixel noise value obtained from the pixel circuit 100 in the reset phase of a row readout period and from the pixel data value obtained from the same pixel circuit 100 in the data phase of the same row readout period, wherein the data phase may follow or precede the reset phase. For example, the ALU may perform DCDS (digital correlated double sampling) by subtracting the pixel noise value from the pixel data value obtained from the same pixel circuit 100 in the same row readout period.

The digital processing unit 40 may include a row noise block 41 that continuously receives the pixel noise values DR from pixel circuits connected to at least one of the column signal processing circuits 200. The row noise block 41 may statistically evaluate the pixel noise values DR from the same pixel circuits 100 from which the pixel data values DS originate. The row noise block 41 may output various control and/or data signals which are based on the results of the evaluation. The various control and/or data signals can be used in various ways to reduce noise and/or improve device safety.

In the illustrated embodiment, the digital processing unit 40 includes one row noise block 41 per column signal processing unit 200, wherein the row noise blocks 41 operate independently from each other. Alternatively, each row noise block 41 may receive the pixel noise values DR from a plurality of column signal processing units 200. Alternatively, the solid-state imaging device 90 may include one single row noise block 41 that can receive the pixel noise values DR of one pixel column, some of the pixel columns or all pixel columns of the solid-state imaging device 90.

The sensor controller 50 generates the driver timing signal and outputs the driver timing signals to the row decoder/driver 30. The sensor controller 50 generates readout control signals for controlling the column signal processing unit 20 through readout control lines 14. The readout control signals may control the analog-to-digital conversion of the analog pixel signals.

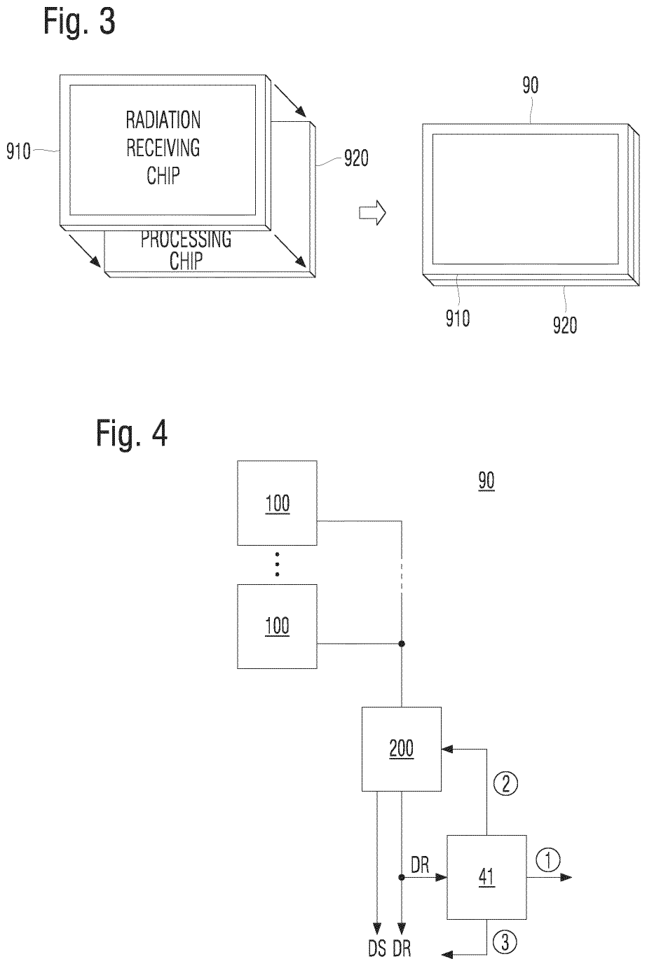

FIG. 3 is a diagram illustrating an example in which the solid-state imaging device 90 of FIG. 2 is formed by a stacked CMOS image sensor (CIS) having a two-layer structure with a radiation receiving chip 910 and a processing chip 920. The radiation receiving chip 910 includes at least the photoelectric conversion elements. For example, the radiation receiving chip 910 may include only the photoelectric conversion elements, or parts of the pixel circuits including the photoelectric conversion element and one or more transistors, or the complete pixel circuits, or the complete pixel circuits and elements of the column signal processing circuits 200. As illustrated on the right-hand side of FIG. 3, the solid-state imaging device 90 is formed as one sensor by bonding the radiation receiving chip 910 and the processing chip 920 while electrically bringing contact pads on the radiation receiving chip 910 in contact with corresponding contact pads on the processing chip 920.

FIG. 4 shows elements of a solid-state imaging device 90 in accordance with the present disclosure.

The solid-state imaging device 90 includes a plurality of pixel circuits 100. Each pixel circuit 100 outputs a pixel data signal and a pixel noise signal. A voltage level of the pixel data signal is a function of an intensity of incident radiation detected in an exposure period. A voltage level of the pixel noise signal is a function of temporal noise in the pixel circuit 100 and independent from the incident radiation. Column signal processing circuits 200 convert the pixel data signals into digital pixel data values DS and the pixel noise signals into digital pixel noise values DR. A row noise block 41 continuously obtains a parameter of a distribution of the pixel noise values DR and outputs a signal based on the parameter.

The parameter obtained by the row noise block may be the variance of the distribution of the pixel noise values DR, wherein a previously calculated variance is continuously updated with each new pixel noise value. Alternatively or in addition, the row noise block may calculate and output an average value of the distribution of the pixel noise values DR, wherein a previously calculated average value is continuously updated with each new pixel noise value. Alternatively or in addition, the row noise block may continuously calculate an offset value of a current pixel noise value from an average value of the distribution of the pixel noise values DR, wherein a previously calculated offset value is continuously updated with each new pixel noise value.

The pixel circuits 100 may be any type of active pixel circuit with one or more photoelectric conversion elements and with four, five or more transistors for controlling exposure, pixel-internal charge transfer, reset, and readout of the pixel circuit 100. The analog pixel signals of one pixel column are sequentially output to a data signal line 19 connecting the pixel circuits 100 of the same column with a column signal processing circuit 200 in row readout periods. In each row readout period, one of the pixel circuits 100 of a pixel column is selected and connected to the data signal line 19. In each row readout period, the pixel noise signal and the pixel data signal are successively read out from the same pixel circuit and the value of the obtained parameter can be updated after each new row readout with the pixel noise value of the last row readout.

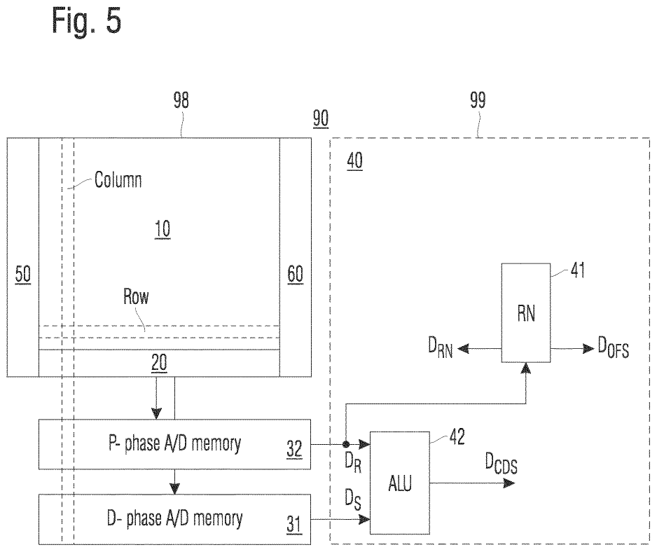

FIG. 5 shows an analog core 98 and a digital core 99 of a solid-state imaging device 90. The analog core 98 includes functional blocks substantially based on analog signal processing. In the illustrated embodiment, the analog core 98 includes the pixel array 10, the column signal processing unit 20, the row decoder/driver 30, and a global processing unit 60. The column signal processing unit 20 passes the pixel noise values DR and the pixel data values DS for each pixel column to the data phase memory 31 and the reset phase memory 32.

The digital core 99 includes a row noise block 41 that obtains a parameter of a distribution of the pixel noise values DR from one pixel column, some of the pixel columns or all pixel columns and outputs a signal based on the parameter.

The row noise block 41 may be configured to continuously obtain the parameter of a distribution of the pixel noise values DR by using a recursive or accumulative calculation method.

Recursive and accumulative computation methods do not require additional memory to cache a great number of pixel noise values DR from different row readout periods, so the obtained parameter can be continuously updated with little additional circuitry.

The solid-state imaging device 90 may include a digital processing unit 40 that includes the row noise block 41 and an arithmetic logic unit 42. The arithmetic logic unit 42 obtains a corrected pixel value DCDS by subtracting the pixel noise value DR obtained in a row readout period from the pixel data value DS obtained in the same row readout period.

The digital processing unit 40 is part of the digital core. The digital core may be completely implemented in hardware or completely in software or may include both hardware components and software components. For example, the digital core may include an application specific integrated circuit (ASIC), a digital signal processor (DSP) and/or program code stored in a local program memory. Alternatively, the digital core and at least some of the analog circuits are included in the same chip.

The parameter may be a variance DRN of the distribution of the pixel noise values DR. The row noise block 41 may be configured to obtain the variance DRN using a recursive calculation method.

The recursive calculation method may be based on Welford's algorithm by way of example. The variance is updated with each new pixel noise value obtained from the last row readout.

The row noise block 41 may obtain the variance DRN for the distribution of the pixel noise values DR from pixel circuits 100 connected to a plurality of the column signal processing circuits 200.

For example, the row noise block 41 may receive the pixel noise values from all pixel columns and obtain the variance DRN for the distribution of the pixel noise values DR from all pixel circuits 100 of the pixel array 10. Alternatively, the row noise block 41 may receive the pixel noise values from one single pixel columns and obtain the variance DRN for the distribution of the pixel noise values DR for one pixel column, wherein a row noise block 41 may be provided for one, some or all pixel columns.

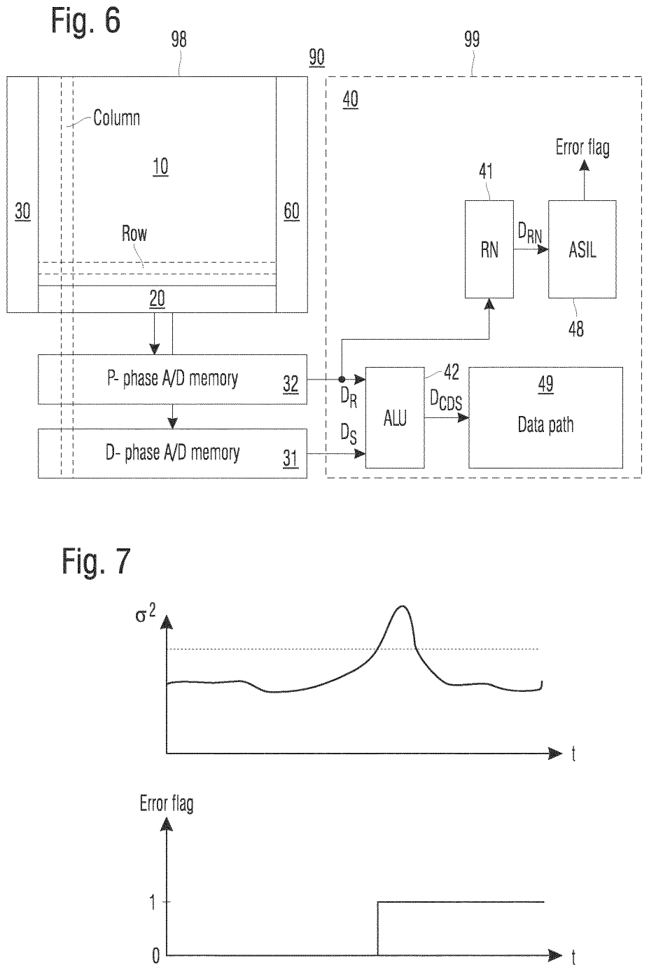

FIG. 6 shows a solid-state imaging device 90 that includes a safety integrity block 48 to continuously monitor the variance DRN for the distribution of pixel noise values DR received from pixel circuits 100 connected to the plurality of the column signal processing circuits 200. The safety integrity block 48 outputs an active error signal, when the monitored variance DRN exceeds a predetermined threshold value.

The active error signal can be used to indicate that the solid-state imaging device is subject to electromagnetic interference (EMI), wherein unwanted noise or interference can distort the image information and/or can cause a malfunction of the solid-state imaging device 90. For example, DC/DC converters may cause significant noise in the solid-state imaging device 90.

The safety integrity block 48 may assess the variance of a single pixel column. According to an embodiment, the row noise block 41 may obtain q variances DRN(q) for q distributions of the pixel noise values DR from pixel circuits 100 connected to p column signal processing circuits 200.

The safety integrity block 48 may continuously monitor the variances DRN (q) for q distributions of the pixel noise values DR from pixel circuits 100 connected to p data signal lines 19 and to output an active error signal, when a predetermined number of the monitored variances DRN(q) fulfills a predetermined condition.

For example, the safety integrity block 48 outputs an active error signal when at least one of the variances DRN(q), a majority of the variances DRN(q), or all variances DRN(q) exceed a predefined threshold.

In FIG. 7, the upper diagram shows the variation of the variance σ² over time. At t=t1 the variance σ² exceeds the threshold thr and the error signal becomes active. The error signal can remain active until a waiting time has elapsed or until an error acknowledgment signal is received.

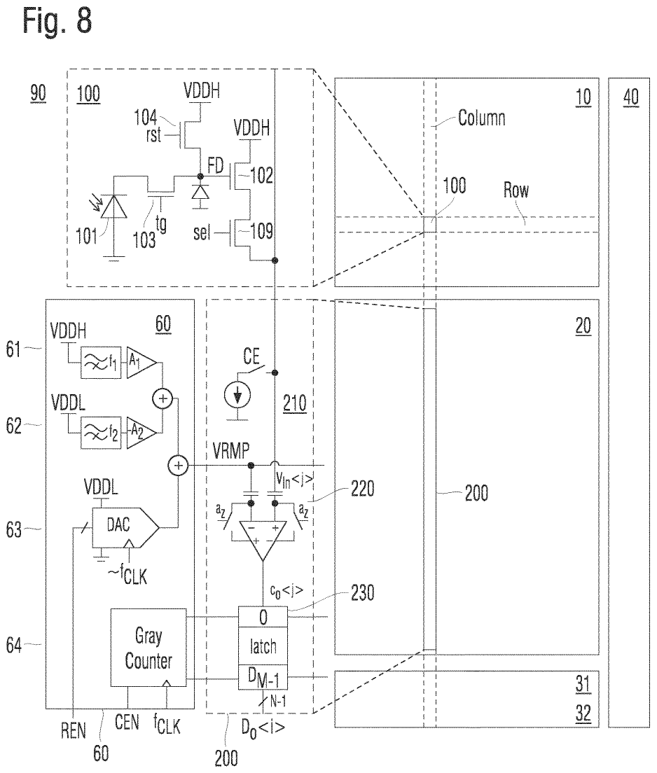

FIG. 8 shows a solid-state imaging device 90 with a pixel array 10 including a plurality of pixel circuits 100, a column signal processing unit 20 including a plurality of column signal processing circuits 200, a data phase memory 31, a reset phase memory 32, a digital processing unit 40, and a global processing unit 60 that includes a first noise reduction circuit 61, a second noise reduction circuit 62, a voltage ramp circuit 63, and a counter circuit 64

The illustrated pixel circuit 100 includes a photoelectric conversion element 101 that photoelectrically converts incident electromagnetic radiation into electric charges. The amount of electric charge generated in the photoelectric conversion element 101 corresponds to the intensity of the incident electromagnetic radiation. The photoelectric conversion element 101 may include or consist of a photodiode which converts electromagnetic radiation incident on a detection surface into a detector current by means of the photoelectric effect. The electromagnetic radiation may include visible light, infrared radiation and/or ultraviolet radiation. The amplitude of the detector current corresponds to the intensity of the incident electromagnetic radiation, wherein in the intensity range of interest the detector current increases approximately linearly with increasing intensity of the detected electromagnetic radiation.

A floating diffusion FD stores charge supplied from the photoelectric conversion element 101 in a transfer period. A floating diffusion voltage vfd of the floating diffusion FD depends on the state of the pixel circuit 100: In a reset phase, the floating diffusion voltage vfd is a function of the pixel dark current. In a data phase, the floating diffusion voltage vfd is a function of the brightness (illumination intensity) sampled by the pixel circuit 100.

A load path of a transfer transistor 103 is electrically connected between a cathode of the photoelectric conversion element 101 and the floating diffusion region FD. The transfer transistor 103 serves as transfer element for transferring charge from the photoelectric conversion element 101 to the floating diffusion region FD in a transfer period. The floating diffusion region FD serves as temporary local charge storage.

A transfer signal tg is supplied to the gate (transfer gate) of the transfer transistor 103 through a transfer control line. The transfer signal tg changes between an active signal level (“active transfer signal”) and an inactive signal level (“inactive transfer signal”). In response to an active transfer signal tg, the transfer transistor 103 transfers electrons photoelectrically converted by the photoelectric conversion element 101 to the floating diffusion region FD. In the illustrated embodiment, the active signal level is the high level.

A load path of a reset transistor 104 is electrically connected between the positive pixel supply voltage VDDH and the floating diffusion region FD. The reset transistor 104 serves as a reset element that resets the floating diffusion potential vfd of the floating diffusion region FD. A pixel reset signal rst is supplied to the gate of the reset transistor 104 through a reset control line. The pixel reset signal rst changes between an active signal level (“active pixel reset signal”) and an inactive signal level (“inactive pixel reset signal”). In the illustrated embodiment, the active signal level is the high level. An active pixel reset signal rst sets the floating diffusion potential vfd equal to or approximately equal to a pixel reset voltage. The pixel reset voltage may be a fixed voltage, e.g., the positive pixel supply voltage VDDH, or may be adaptive and controlled by a threshold drift compensation circuit.

An amplifier transistor 102 is in a source follower configuration, with the controlled load path electrically connected between the positive pixel supply potential VDDH and the data signal line 19. The floating diffusion region FD is connected to the gate of the amplifier transistor 102. A potential at the gate of the amplifier transistor 102 is equal to the floating diffusion voltage vfd. The floating diffusion region FD functions as the input node of the amplifier transistor 102.

A select transistor 109 controls a sequential readout of all pixel circuits 100 connected to the same data signal line 19. Load paths of the amplifier transistor 102 and the select transistor 109 are electrically connected in series between the positive pixel supply voltage VDDH and the data signal line 19. The select transistor 109 electrically couples the amplifier transistor 102 to the data signal line 19 in a row readout period. In particular, the select transistor 109 connects the controlled load path between source and drain of the amplifier transistor 102 to the data signal line 19 when the pixel circuit 100 is selected and disconnects the amplifier transistor 102 from the data signal line 19 when the pixel circuit 100 is not selected.

A row select signal sel for a pixel row is supplied to the gate of the select transistor 109 through a select control line. The row select signal sel changes between an active signal level (“active select signal”) and an inactive signal level (“active select signal”). In the illustrated embodiment, the active signal level is the high level.

The pixel circuits 100 output the analog pixel signals for a reset phase (pixel noise signal) and a data phase (pixel data signal) sequentially on the same data signal line 19 or simultaneously on a pair of data signal lines 19.

The data lines 19 connect the pixel array 10 with the column signal processing unit 20. In the illustrated embodiment, each column signal processing circuit 200 is connected to one data signal line 19 or to one pair of data signal lines 19 and receives the analog pixel signals of the pixel circuits 100 assigned to one pixel column. Alternatively, each column signal processing circuit 200 may be connected to or connectable to more than one data signal line 19 or more than one pair of data signal lines 19 and receive the analog pixel signals of the pixel circuits 100 from more than one pixel column.

Each column signal processing circuit 200 includes a current source circuit 210, a comparator circuit 220, and a latch circuit 230.

The current source circuit 210 is a constant current source and complements the amplifier transistor 102 in the selected pixel circuit 100 to a source follower that outputs the analog pixel signal of a selected pixel circuit 100 to a first input of the comparator circuit 220 in a row readout period. The current source circuit 210 may sink or source a constant current.

The voltage ramp circuit 63 outputs a voltage ramp signal VRMP to the column signal processing circuits 200 for converting the pixel data signals into digital pixel data values DS and the pixel noise signals into digital pixel noise values DR.

The voltage ramp circuit 63 outputs the voltage ramp signal VRMP in response to an active ramp power enable signal REN. The voltage ramp signal VRMP may decrease from a high voltage level to a low voltage level continuously or in small steps at a rate significantly lower than leading and trailing edges of a row select signal. Alternatively, the voltage ramp signal VRMP may increase from a low voltage level to a high voltage level continuously or in small steps at a rate significantly lower than leading and trailing edges of a row select signal. The voltage ramp signal VRMP is applied to the second input of the comparator circuit 220 in the row readout periods. The comparator circuit 220 outputs an active comparator output signal CO when the voltage level of a falling voltage ramp signal VRMP falls below the voltage level of the analog pixel signal applied to the first input of the comparator circuit 220, or when the voltage level of a rising voltage ramp signal VRMP exceeds the voltage level of the analog pixel signal applied to the first input of the comparator circuit 220.

The counter circuit 64 outputs a digital count value of a digital counter on a digital bus to data inputs of the latch circuits 230 in response to an active count power enable signal CEN. The active count enable CEN signal and the active ramp power enable signal REN have a predetermined temporal relationship to each other and to the start of the row readout period. The latch circuit 230 latches the instantaneous count value applied to the data inputs with a transition from an inactive comparator output signal to the active comparator output signal CO. The latched count value represents the digital pixel value of the pixel signal obtained from the pixel circuit 100 in the row readout period.

Instead of one counter circuit 64 whose counter values are applied to all latch circuits 230, the global processing unit 60 may include one counter circuit 64 for each latch circuit 230 or for each subset of latch circuits 230. Instead of one voltage ramp generator 63 whose voltage ramp signal VRMP is applied to all comparator circuits 220, the global processing unit 60 may include one voltage ramp generator 63 for each comparator circuit 220 or for each subset of comparator circuits 220.

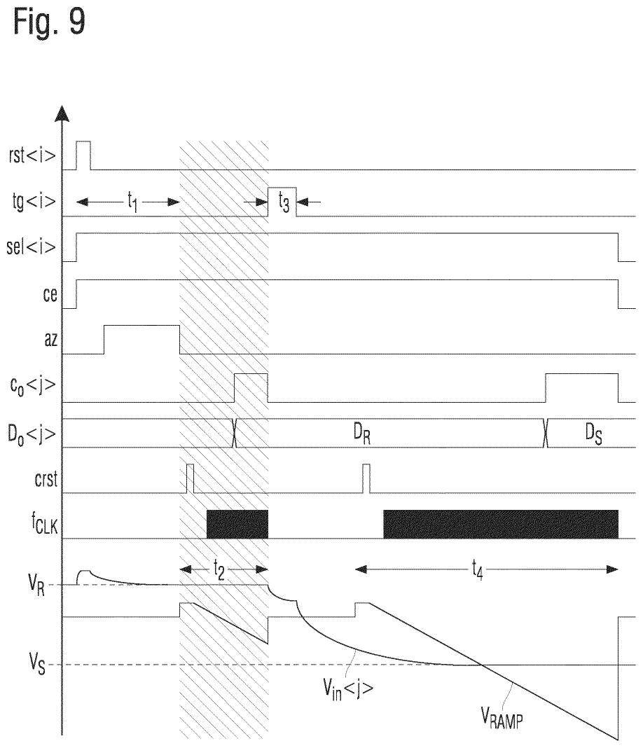

FIG. 9 shows some of the signals indicated in FIG. 8. The reset phase is indicated by the period t2. The data phase is indicated by period t4.

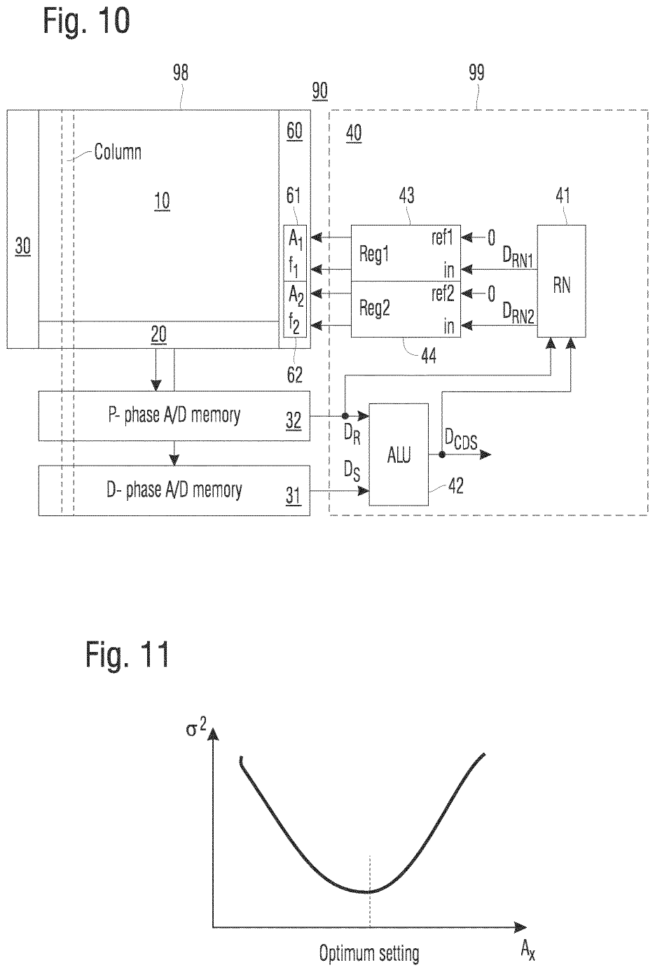

FIG. 10 shows a solid-state imaging device 90 with a digital processing unit 40 including a row noise unit 41 as described above.

The solid-state imaging device 90 further includes a first noise reduction unit 61 configured to output a first noise compensation signal replicating a row temporal noise of a positive pixel supply voltage VDDH supplying the pixel circuits 100 and add the first noise compensation signal to the voltage ramp signal VRMP. The first noise reduction unit 61 has a programmable first gain A1 and/or a programmable first cutoff frequency f1. A first regulator block 43 controls the first gain A1 and/or the first frequency f1 based on the obtained parameter of the distribution of the pixel noise values DR.

The obtained parameter may depend on a variance of the distribution of the pixel noise values DR.

In addition to one or more parameters of the distribution of the pixel noise values DR, the first regulator block 43 may use parameters obtained in an alternative way, for example from the corrected pixel values DCDS.

The first regulator block 43 may use a control loop algorithm to adapt the pixel noise values to a predetermined first reference value ref1.

The first reference value ref1 may be zero, i.e., the first regulator block drives the pixel noise values in direction of zero. For the targeted optimum setting of the programmable parameters of the first noise reduction unit 61, the variance has a minimum as illustrated in FIG. 11.

The solid-state imaging device 90 may further include a second noise reduction unit 62 configured to output a second noise compensation signal replicating a row temporal noise of a positive logic supply voltage VDDL supplying the voltage ramp circuit 63 and add the second noise compensation signal to the voltage ramp signal. The second noise reduction unit 62 has a programmable second gain A2 and/or a programmable second cutoff frequency f2. A second regulator block 44 controls the second gain A2 and/or the second frequency f2 based on the obtained parameter of the distribution of the pixel noise values DR.

The parameter of the distribution of the pixel noise values DR may be obtained from all pixel circuits or from a true subset of all pixel circuits. The parameter may be obtained when the pixel circuits are selected

The obtained parameter may depend on a variance of the distribution of the pixel noise values DR.

In addition to one or more parameters of the distribution of the pixel noise values DR, the second regulator block 44 may use parameters obtained in an alternative way, for example from the corrected pixel values DCDS.

The first regulator block 43 may use a control loop algorithm to adapt the pixel noise values to a predetermined second reference value ref2.

The second reference value ref2 may be zero, wherein the second regulator block drives the pixel noise values to the target value zero. The control loop algorithm will set the optimal transfer function for the row temporal noise subtraction in the column signal processing circuits 200.

A solid-state imaging device 90 may include only the first noise reduction circuit 61 and the first regulator block 43. Alternatively, the solid-state imaging device 90 may include only the second noise reduction circuit 62 and the second regulator block 44.

Alternatively, the solid-state imaging device 90 may include both the first noise reduction circuit 61 combined with the first regulator block 43 and the second noise reduction circuit 62 combined with the second regulator block 44.

The parameters may be based on pixel noise values obtained in specific modes of the solid-state imaging device. For example, the parameters may be obtained from pixel noise values obtained in dummy readouts with no pixel circuits selected or in inserted row readouts with only one or none of the noise reduction circuits enabled.

According to other embodiments, the obtained parameter of the distribution of the pixel noise values is a running average of the pixel noise values DR.

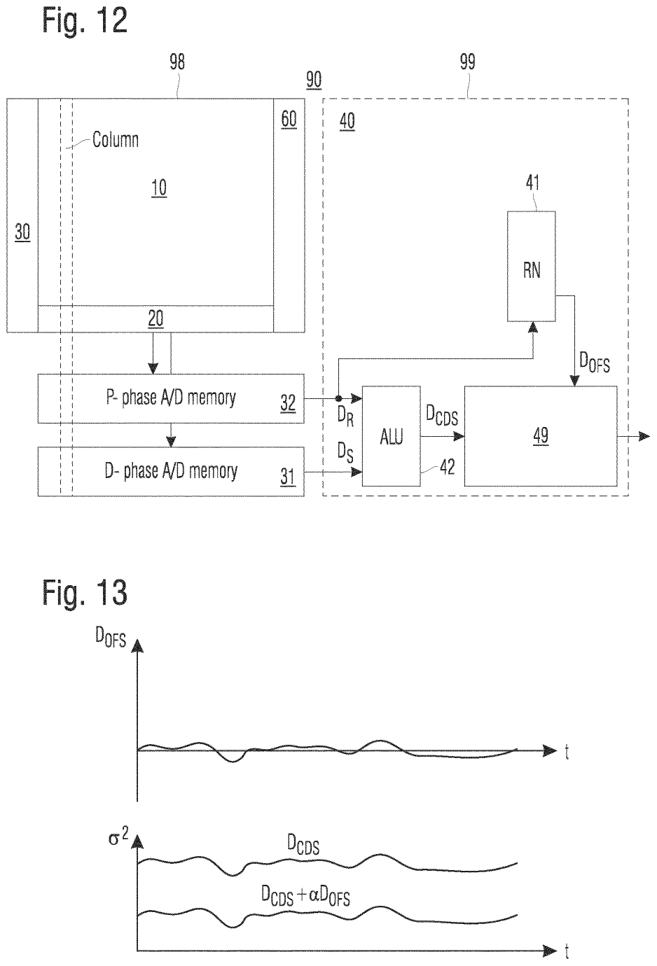

In FIG. 12, the row noise block 41 determines the running average of the pixel noise values DR.

the solid-state imaging device 90 includes a correction unit 49 configured to receive a corrected pixel value DCDS obtained by subtracting the pixel noise value DR obtained in a row readout period from the pixel data value DS obtained in the row readout period and adjust the corrected pixel value DCDS based on information about the running average.

For example, the running average may be obtained from all pixel circuits. A row noise average can be determined based on the pixel noise values of the pixel row that was subject of the last row readout. A row offset between the running average and the row noise average may indicate a row-specific shift up or shift down of the row temporal noise. The row noise block 41 in combination with the correction unit 49 allow to further adjust the corrected pixel value DCDS by subtracting the row offset from the corrected pixel values DCDS for the concerned pixel row

FIG. 13 shows the operating principle of the digital processing unit 40 of FIG. 12. The row noise block calculates a running average of the pixel noise values and an offset DOFS from the running average per row. The upper diagram of FIG. 13 shows the offset DOFS for a pixel row over time. Multiplied with a constant weight factor a, the instantaneous offset DOSF can be used to fine-adjust the corrected digital pixel value DCDS, e.g., by subtracting the weighted instantaneous offset DOSF from the corrected digital pixel value DCDS. The lower diagram in FIG. 13 illustrates the effect of subtracting the weighted instantaneous offset DOSF on the variance of the corrected digital pixel valued DCDS.

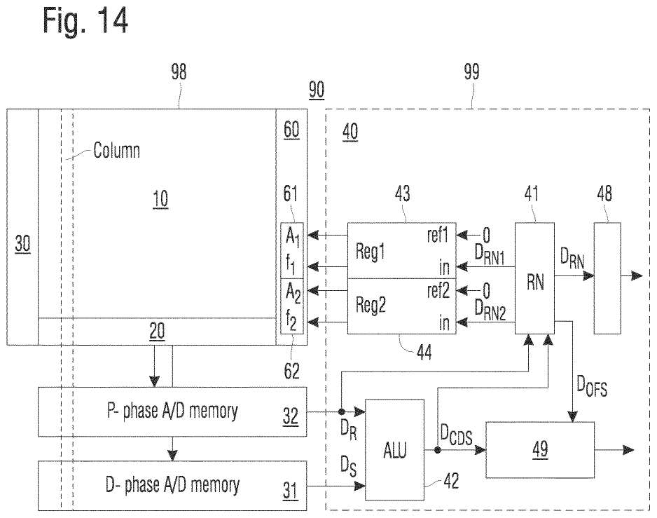

FIG. 14 shows a solid-state imaging device 90 that combines the embodiments of FIG. 6, FIG. 10, and FIG. 12.

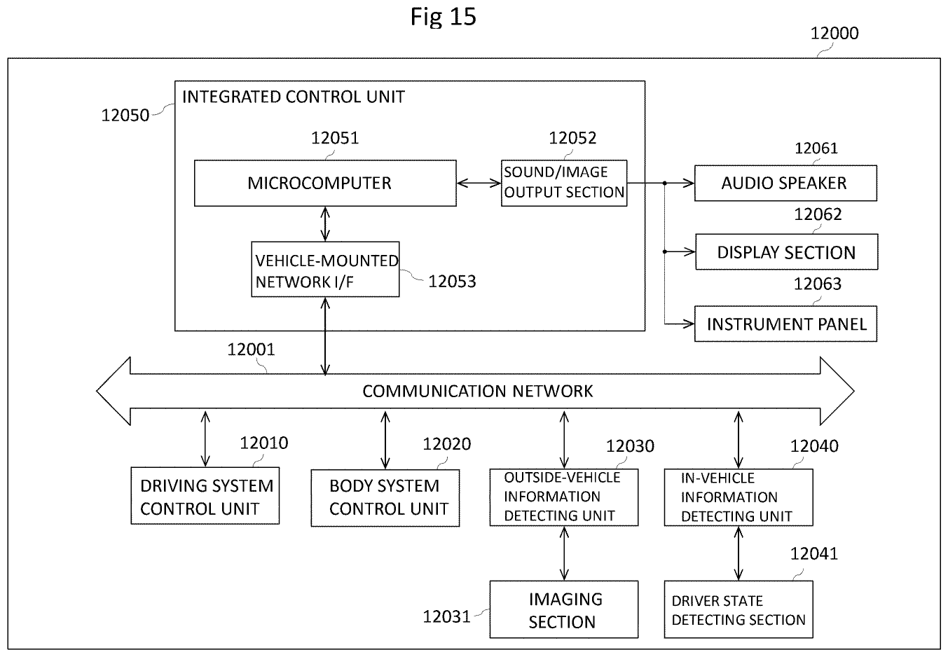

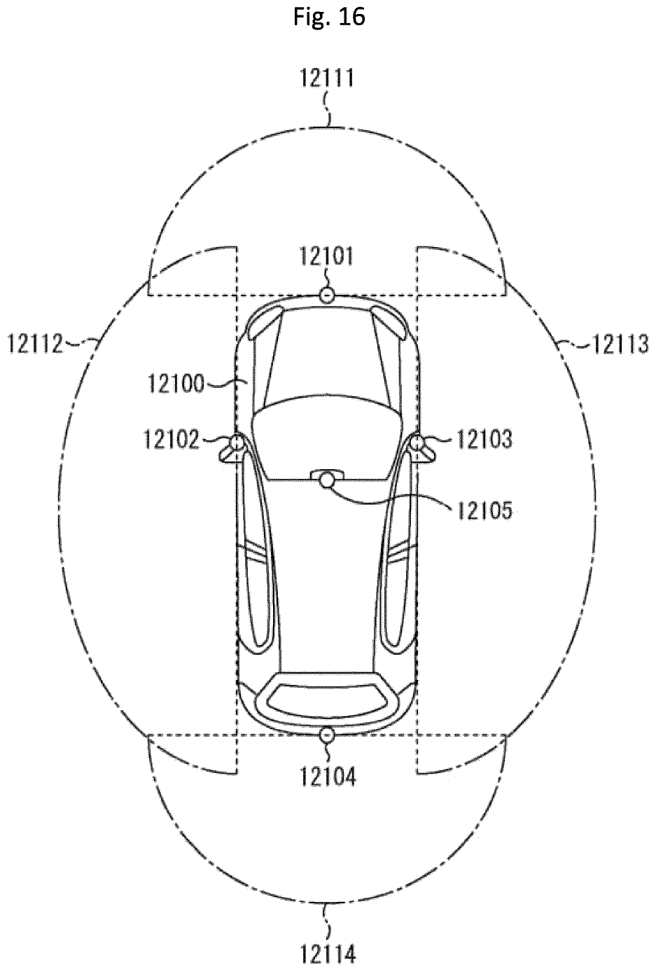

FIG. 15 is a block diagram depicting an example of schematic configuration of a vehicle control system as an example of a system to which the technology according to an embodiment of the present disclosure can be applied.

The vehicle control system 12000 includes a plurality of electronic control units connected to each other via a communication network 12001. In the example depicted in FIG. 15, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. The outside-vehicle information detecting unit 12030 can be connected with an imaging section 12031. The outside-vehicle information detecting unit 12030 makes the imaging section 12031 imaging an image of the outside of the vehicle and receives the imaged image. Based on the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include a solid-state imaging device with a row noise block for noise reduction according to the embodiments of the present disclosure. The light received by the imaging section 12031 may be visible light or may be invisible light such as infrared rays or the like.

The in-vehicle information detecting unit 12040 detects information about the inside of the vehicle and may be or may include a solid-state imaging device with a row noise block for noise reduction according to the embodiments of the present disclosure. The in-vehicle information detecting unit 12040 is, for example, connected with a driver state detecting section 12041 that detects the state of a driver. The driver state detecting section 12041, for example, includes a camera that includes the solid-stage imaging device and that is focused on the driver. Based on detection information input from the driver state detecting section 12041, the in-vehicle information detecting unit 12040 may calculate a degree of fatigue of the driver or a degree of concentration of the driver or may determine whether the driver is dozing.

The microcomputer 12051 can calculate a control target value for the driving force generating device, the steering mechanism, or the braking device based on the information about the inside or outside of the vehicle which information is obtained by the outside-vehicle information detecting unit 12030 or the in-vehicle information detecting unit 12040 and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 based on the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 15, an audio speaker 12061, a display section 12062, and an instrument panel 12063 are illustrated as the output device. The display section 12062 may, for example, include at least one of an on-board display or a head-up display.

FIG. 16 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 16 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, imaging element having pixels for phase difference detection or may include a ToF module including a solid-state imaging device with a row noise block for noise reduction according to the embodiments of the present disclosure.

For example, the microcomputer 12051 can determine a distance to each three-dimensional object within the imaging ranges 12111 to 12114 and a temporal change in the distance (relative speed with respect to the vehicle 12100 on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062 and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to an embodiment of the present disclosure is applicable has been described above. By applying a solid-state imaging device with a row noise block for noise reduction according to the embodiments of the present disclosure, better noise reduction and improved processing of the image data can be achieved.

Additionally, embodiments of the present technology are not limited to the above-described embodiments, but various changes can be made within the scope of the present technology without departing from the gist of the present technology.

The image sensor with pixel circuits according to the present disclosure may be any device used for analyzing and/or processing radiation such as visible light, infrared light, ultraviolet light, and X-rays. For example, a solid-state imaging device with a row noise block for noise reduction according to the embodiments may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device with a row noise block for noise reduction according to the embodiments may be a device for capturing an image to be provided for appreciation, such as a digital camera, a smart phone, or a mobile phone device having a camera function. In the field of traffic, for example, the solid-state imaging device with a row noise block for noise reduction according to the embodiments may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the image sensor with pixel circuits according to the embodiments may be integrated in any type of sensor that can be used in devices provided for home appliances such as TV receivers, refrigerators, and air conditioners to capture gestures of users and perform device operations according to the gestures. Accordingly, the image sensor with pixel circuits according to the embodiments may be integrated in home appliances such as TV receivers, refrigerators, and air conditioners and/or in devices controlling the home appliances. Furthermore, in the field of medical and healthcare, the image sensor with pixel circuits according to the embodiments may be integrated in any type of sensor, e.g., a solid-state image device, provided for use in medical and healthcare, such as an endoscope or a device that performs angiography by receiving infrared light.

In the field of security, the image sensor with pixel circuits according to the embodiments can be integrated in a device provided for use in security, such as a monitoring camera for crime prevention or a camera for person authentication use. Furthermore, in the field of beauty, an image sensor with pixel circuits according to the embodiments can be used in a device provided for use in beauty, such as a skin measuring instrument that captures skin or a microscope that captures a probe. In the field of sports, an image sensor with pixel circuits according to the embodiments can be integrated in a device provided for use in sports, such as an action camera or a wearable camera for sport use or the like. Furthermore, in the field of agriculture, the image sensor with pixel circuits can be used in a device provided for use in agriculture, such as a camera for monitoring the condition of fields and crops.

The present technology can also be configured as described below:
[1] A solid-state imaging device, including a plurality of pixel circuits (100), each pixel circuit (100) configured to output a pixel data signal and a pixel noise signal, wherein a voltage level of the pixel data signal is a function of an intensity of incident radiation detected in an exposure period and a voltage level of the pixel noise signal is a function of temporal noise in the pixel circuit (100) and independent from the incident radiation; a column signal processing circuit (200) configured to convert the pixel data signals into digital pixel data values DS and the pixel noise signals into digital pixel noise values DR; and a row noise block (41) configured to continuously obtain a parameter of a distribution of the pixel noise values DR and output a signal based on the parameter.
[2] The solid-state imaging device (90) according to [1], wherein the row noise block (41) is configured to obtain the parameter of a distribution of the pixel noise values DR by using a recursive or accumulative calculation method.
[3] The solid-state imaging device (90) according to any of [1] and [2], including a digital processing unit (40) including the row noise block (41) and an arithmetic logic unit (42), wherein the arithmetic logic unit (42) is configured to obtain a corrected pixel value DCDS by subtracting the pixel noise value DR obtained in a row readout period from the pixel data value DS obtained in the row readout period.
[4] The solid-state imaging device (90) according to any of [1] and [3], wherein the parameter is a variance DRN of the distribution of the pixel noise values DR, and the row noise block (41) is configured to obtain the variance DRN using a recursive calculation method.
[5] The solid-state imaging device (90) according to [4], wherein the row noise block (41) is configured to obtain the variance DRN for a distribution of the pixel noise values DR from the pixel circuits (100) connected to a plurality of the column signal processing circuits (200).
[6] The solid-state imaging device (90) according to [5], further including: a safety integrity block (48) configured to continuously monitor the variance DRN for the distribution of the pixel noise values DR from the pixel circuits (100) connected to the plurality of the column signal processing circuits (200) and to output an active error signal, when the monitored variance DRN exceeds a predetermined threshold value.
[7] The solid-state imaging device (90) according to any of [4] to [6], wherein the row noise block (41) is configured to obtain q variances DRN(q) for q distributions of the pixel noise values DR from pixel circuits (100) connected to p data signal lines (19).
[8] The solid-state imaging device (90) according to [7], further including: a safety integrity block (48) configured to continuously monitor the variances DRN (q) for q distributions of the pixel noise values DR from pixel circuits (100) connected to p data signal lines (19) and to output an active error signal, when a predetermined number of the monitored variances DRN(q) fulfills a predetermined condition.
[9] The solid-state imaging device (90) according to any of [1] to [8], further including: a voltage ramp circuit (63) configured to output a voltage ramp signal to the column signal processing circuits (200) for converting the pixel data signals into digital pixel data values DS and the pixel noise signals into digital pixel noise values DR.
[10] The solid-state imaging device (90) according to [9], further including: a first noise reduction unit (61) configured to output a first noise compensation signal replicating a row temporal noise of a positive pixel supply voltage VDDH supplying the pixel circuits (100) and add the first noise compensation signal to the voltage ramp signal, wherein the first noise reduction unit (61) has a programmable first gain A1 and/or a programmable first cutoff frequency f1; and
   a first regulator block (43) configured to control the first gain A1 and/or the first frequency f1 based on the obtained parameter of the distribution of the pixel noise values DR.
[11] The solid-state imaging device (90) according to [10], wherein the obtained parameter depends on a variance of the distribution of the pixel noise values DR.
[12] The solid-state imaging device (90) according to any of [10] to [11], wherein the first regulator block (43) uses a control loop algorithm to adapt the pixel noise values to a predetermined first reference value.
[13] The solid-state imaging device (90) according to any of [9] to [12], further including: a second noise reduction unit (62) configured to output a second noise compensation signal replicating a row temporal noise of a positive logic supply voltage VDDL supplying the voltage ramp circuit (63) and add the second noise compensation signal to the voltage ramp signal, wherein the second noise reduction unit (62) has a programmable second gain A2 and/or a programmable second cutoff frequency f2; and a second regulator block (44) configured to control the second gain A2 and/or the second frequency f2 based on the obtained parameter of the distribution of the pixel noise values DR.
[14] The solid-state imaging device (90) according to claim 13, wherein the obtained parameter depends on a variance of the distribution of the pixel noise values DR.
[15] The solid-state imaging device (90) according to any of [13] to [14], wherein the second regulator block (44) uses a control loop algorithm to adapt the pixel noise values to a predetermined first reference value.
[16] The solid-state imaging device (90) according to any of [1] to [15], wherein the obtained parameter of the distribution of the pixel noise values is a running average of the pixel noise values DR.
[17] The solid-state imaging device (90) according to [16], further including: a correction unit (49) configured to receive a corrected pixel value DCDS obtained by subtracting the pixel noise value DR obtained in a row readout period from the pixel data value DS obtained in the row readout period and adjust the corrected pixel value DCDS based on information about the running average.

1. A solid-state imaging device, comprising:
a plurality of pixel circuits, each pixel circuit configured to output a pixel data signal and a pixel noise signal, wherein a voltage level of the pixel data signal is a function of an intensity of incident radiation detected in an exposure period and a voltage level of the pixel noise signal is a function of temporal noise in the pixel circuit and independent from the incident radiation;
a column signal processing circuit configured to convert the pixel data signals into digital pixel data values DS and the pixel noise signals into digital pixel noise values DR; and
a row noise block configured to continuously obtain a parameter of a distribution of the pixel noise values DR and output a signal based on the parameter.

2. The solid-state imaging device according to claim 1,
wherein the row noise block is configured to obtain the parameter of a distribution of the pixel noise values DR by using a recursive or accumulative calculation method.

3. The solid-state imaging device according to claim 1, comprising
a digital processing unit comprising the row noise block and an arithmetic logic unit, wherein the arithmetic logic unit is configured to obtain a corrected pixel value DCDS by subtracting the pixel noise value DR obtained in a row readout period from the pixel data value DS obtained in the row readout period.

4. The solid-state imaging device according to claim 1,
wherein the parameter is a variance DRN of the distribution of the pixel noise values DR, and the row noise block is configured to obtain the variance DRN using a recursive calculation method.

5. The solid-state imaging device according to claim 4,
wherein the row noise block is configured to obtain the variance DRN for a distribution of the pixel noise values DR from the pixel circuits connected to a plurality of the column signal processing circuits.

6. The solid-state imaging device according to claim 5, further comprising:
a safety integrity block configured to continuously monitor the variance DRN for the distribution of the pixel noise values DR from the pixel circuits connected to the plurality of the column signal processing circuits and to output an active error signal, when the monitored variance DRN exceeds a predetermined threshold value.

7. The solid-state imaging device according to claim 4,
wherein the row noise block is configured to obtain q variances DRN(q) for q distributions of the pixel noise values DR from pixel circuits connected to p data signal lines.

8. The solid-state imaging device according to claim 7, further comprising:
a safety integrity block configured to continuously monitor the variances DRN (q) for q distributions of the pixel noise values DR from pixel circuits connected to p data signal lines and to output an active error signal, when a predetermined number of the monitored variances DRN(q) fulfills a predetermined condition.

9. The solid-state imaging device according to claim 1, further comprising:
a voltage ramp circuit configured to output a voltage ramp signal to the column signal processing circuits for converting the pixel data signals into digital pixel data values DS and the pixel noise signals into digital pixel noise values DR.

10. The solid-state imaging device according to claim 9, further comprising:
a first noise reduction unit configured to output a first noise compensation signal replicating a row temporal noise of a positive pixel supply voltage VDDH supplying the pixel circuits and add the first noise compensation signal to the voltage ramp signal, wherein the first noise reduction unit has a programmable first gain A1 and/or a programmable first cutoff frequency f1; and
a first regulator block configured to control the first gain A1 and/or the first frequency f1 based on the obtained parameter of the distribution of the pixel noise values DR.

11. The solid-state imaging device according to claim 10,
wherein the obtained parameter depends on a variance of the distribution of the pixel noise values DR.

12. The solid-state imaging device according to claim 10,
wherein the first regulator block uses a control loop algorithm to adapt the pixel noise values to a predetermined first reference value.

13. The solid-state imaging device according to claim 9, further comprising:
a second noise reduction unit configured to output a second noise compensation signal replicating a row temporal noise of a positive logic supply voltage VDDL supplying the voltage ramp circuit and add the second noise compensation signal to the voltage ramp signal, wherein the second noise reduction unit has a programmable second gain A2 and/or a programmable second cutoff frequency f2; and
a second regulator block configured to control the second gain A2 and/or the second frequency f2 based on the obtained parameter of the distribution of the pixel noise values DR.

14. The solid-state imaging device according to claim 13,
wherein the obtained parameter depends on a variance of the distribution of the pixel noise values DR.

15. The solid-state imaging device according to claim 13,
wherein the second regulator block uses a control loop algorithm to adapt the pixel noise values to a predetermined first reference value.

16. The solid-state imaging device according to claim 1,
wherein the obtained parameter of the distribution of the pixel noise values is a running average of the pixel noise values DR.

17. The solid-state imaging device according to claim 16, further comprising:
a correction unit configured to receive a corrected pixel value DCDS obtained by subtracting the pixel noise value DR obtained in a row readout period from the pixel data value DS obtained in the row readout period and adjust the corrected pixel value DCDS based on information about the running average.
